(19) United States
(12) Patent Application Publication
(10) Pub. No.: US 2010/0018744 A1
(43) Pub. Date: Jan. 28, 2010

(54) METHOD FOR ARRANGING A CABLE, CABLE AND FERRULE TO BE USED IN THE METHOD

(75) Inventors: Claude Casses, Cleviliers (FR); Patrice Cappe, Faverolles (FR)

Correspondence Address: HARRINGTON & SMITH, PC, 4 RESEARCH DRIVE, Suite 202, SHELTON, CT, 06484-6212, US

(73) Assignee: FCI, Versailles (FR)

(21) Appl. No.: 12/309,752

(22) PCT Filed: Jul. 27, 2006
(86) PCT No.: PCT/IB2006/054094

§ 371 Date: Oct. 1, 2009

(51) Int. Cl. H01B 9/02; H01B 7/00; B23P 11/00

(52) U.S. Cl. 174/107; 174/135; 29/428

(57) ABSTRACT

The cable includes a conductive cable core, an inner insulating sheath covering the cable core, a conductive sheath covering the inner insulating sheath, and an outer insulating sheath covering the conducting sheath, except for a revealed portion of the conductive sheath extending from an end of the cable, wherein the revealed portion has an end opposite the outer insulating sheath. The method includes the steps of, while maintaining the free end of the conductive sheath in contact with the inner insulating sheath, pushing up the end of the revealed portion of the conductive sheath from the end of the cable for revealing a portion of the inner insulating sheath and causing the revealed portion of the conductive sheath to crumple, forming an annular nipple, and blocking the pushed up portion of the conductive sheath.

### FIELD OF THE INVENTION

The present invention relates to a method for arranging a cable for the purpose of connecting the cable to a device. The method further relates to a cable arrangement and a ferrule for being used in the method.

### BACKGROUND OF THE INVENTION

The invention is intended to be used on any type of shielded cable, and in particular on power cables used in hybrid motors in the automotive industry, using fuel and electrical power.

A shielded cable typically comprises:
a conductive cable core,
an inner insulating sheath covering the cable core,
a conductive sheath covering the inner insulating sheath, and
an outer insulating sheath covering the conducting sheath.

The conductive sheath is intended to be connected to the ground or shield of a circuit.

It is known to arrange the previous cable for the purpose of connecting the cable to a device, by using a method comprising the steps of:
stripping the outer insulating sheath from an end of the cable for revealing a portion of the conductive sheath,
disposing a first ring around the outer insulating sheath next to the revealed portion of the conductive sheath,
revealing the inner insulating sheath by bending the revealed portion of the conductive sheath so as to bring an end of the revealed portion of the conductive sheath on the first ring,
disposing a second ring on the end of the revealed portion of the conductive sheath, around the first ring, and
crimping the two rings.

The known method requires a lot of cumbersome steps, which therefore take time.

### SUMMARY OF THE INVENTION

The invention aims at decreasing the time required to arrange the cable by decreasing the number of steps.

Therefore, the invention relates to a method for arranging a cable for the purpose of connecting the cable to a device, the cable comprising:
a conductive cable core,
an inner insulating sheath covering the cable core,
a conductive sheath covering the inner insulating sheath, and
an outer insulating sheath covering the conductive sheath, except for a revealed portion of the inductive sheath extending from an end of the cable,

wherein the revealed portion has an end opposite the outer insulating sheath,

the method being characterized in that it comprises the steps of:
while maintaining the end of the revealed portion of the conductive sheath in contact with the inner insulating sheath, pushing up the end of the revealed portion of the conductive sheath along the cable towards the outer insulating sheath for revealing a portion of the inner insulating sheath, and causing the revealed portion of the conductive sheath to crumple, forming an annular ripple, and
blocking the pushed up revealed portion of the conductive sheath.

Thanks to the invention, arranging the cable requires now only two steps, which can be achieved very fast.

Other features of the method are set forth in the dependent claims 2 to 4.

The invention also relates to a cable, comprising:
a conductive cable core,
an inner insulating sheath covering the cable core,
a conductive sheath covering the inner insulating sheath, and
an outer insulating sheath covering the conducting sheath, except for a revealed portion of the inductive sheath extending from an end of the cable, characterized in that the conductive sheath has an end against the inner insulating sheath, the end of the conductive sheath being located along the cable at a distance from the end of the cable, and defines an annular ripple located along the cable between the end of the conductive sheath and the outer insulating sheath.

The invention also relates to a cable arrangement according to claim 6 or 7.

The invention also relates to a ferrule for being used in the method according to the invention, characterized in that it comprises two coaxial rings axially spaced and fixed to each other by a plurality of parallel stripes so as to substantially define a generally cylindrical shape.

Other features of the ferrule are set forth in the dependent claims 9 to 12.

### BRIEF DESCRIPTION OF THE DRAWINGS

The invention will be better understood upon reading the following detailed description of an embodiment of the invention with reference to the accompanying drawings:

FIGS. 1, 2 and 4 to 8 are tri dimensional views illustrating a cable in successive steps of the method of being arranged according to the invention;

FIG. 3 is a tri dimensional view of a ferrule used for arranging the cable; and

FIG. 9 is a tri dimensional view of a raw structure from which the ferrule used for arranging the cable is manufactured.

### DESCRIPTION OF THE PREFERRED EMBODIMENT

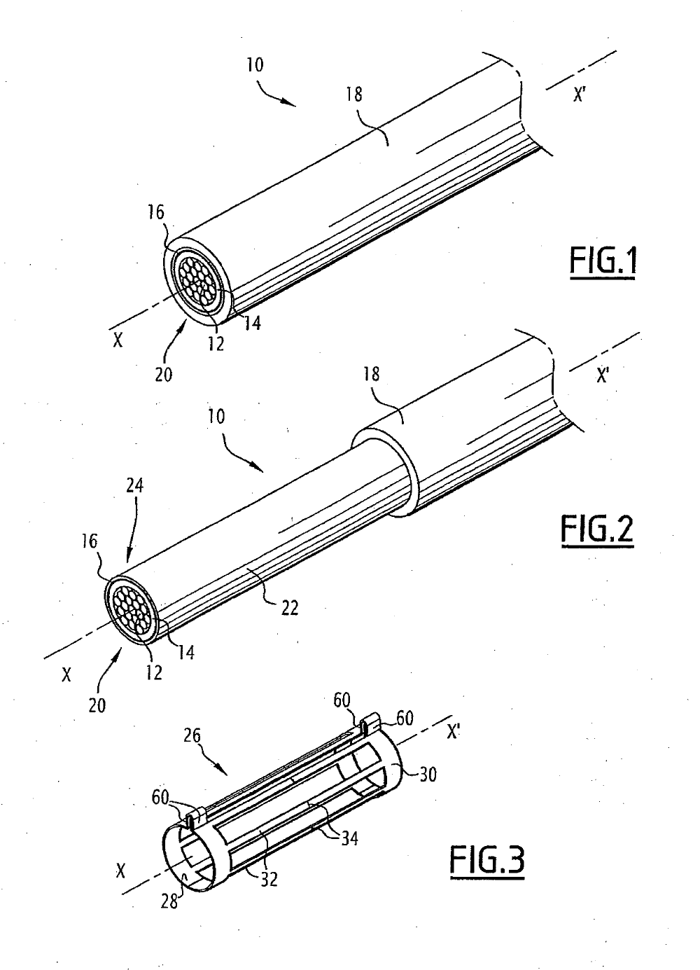

Turning to FIG. 1, a shielded cable 10 comprises a conductive cable core 12, an inner insulating sheath 14 covering the cable core 12, a conductive sheath 16 covering the inner insulating sheath 14, and an outer insulating sheath 18 covering the conducting sheath 16.

The cable core 12 is intended to lead electrical power. The conductive sheath 16 is intended to be connected to the ground or shield of an electrical circuit.

The cable 10 comprises an end 20 defining a cross section of the cable 10. All the layers 12, 14, 16, 18 constituting the cable 10 extend until the end 20 of the cable 10.

In order to be connected, the cable 10 must be arranged so as to reveal the core 12 and the conductive sheath 16.

Turning to FIG. 2, a method for arranging the cable 10 comprises a first step of stripping the outer insulating sheath 18 from the end 20 of the cable 10 for revealing a portion 22 of the conductive sheath 16. This stripping step is achieved for instance by using stripping pliers (not shown). The revealed portion 22 of the conductive sheath 16 extend until an end 24 of that revealed portion 22 located at the end 20 of the cable 10.

Turning to FIG. 3, a cylindrical ferrule 26 is intended to be placed around the cable 10 as will be explained in the following. The ferrule 26 comprises two rings 28, 30 facing each other such that the rings 28, 30 are coaxial along a same central direction X-X′, and axially spaced. The ferrule 26 further comprises a plurality of stripes 32 connecting the two rings 28, 30. The stripes 32 extend along the central direction X-X′ of the rings 28, 30. The stripes 32 are equally spaces around the girth of the rings 28, 30. Each stripe 32 is provided with a notch 34 perpendicular to the central direction X-X′. The notch 34 is located halfway between the two rings 28, 30. The notches 34 are intended to facilitate the bending of the stripes 32 at the half of the stripes 32. Each ring 28, carries two strips 60 crimped together, used for manufacturing the ferrule 26. This aspect of the invention will be explained further with reference with FIG. 9.

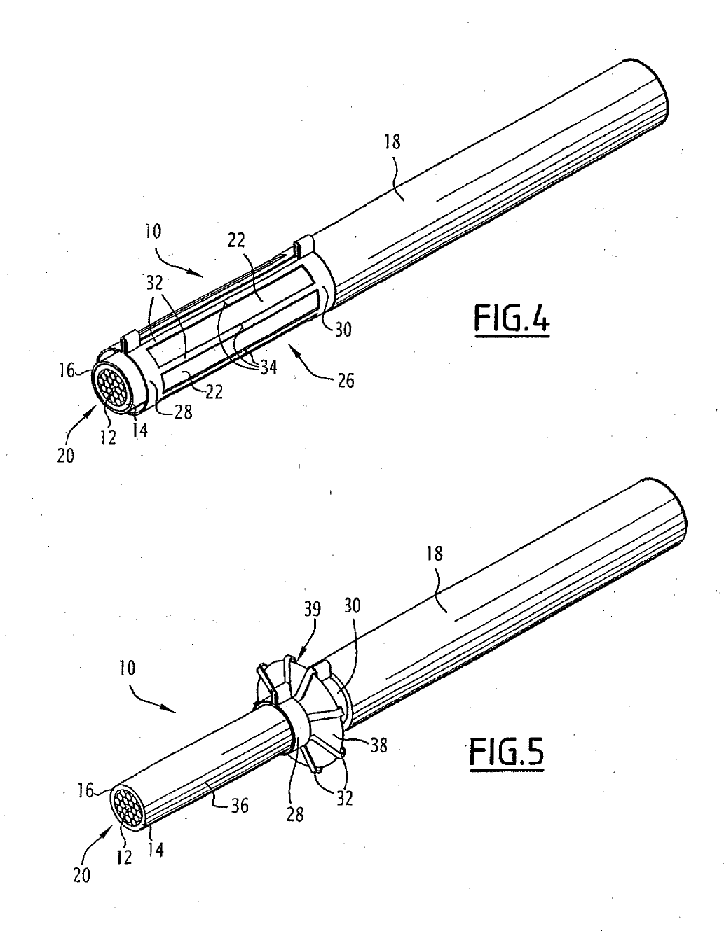

Turning to FIG. 4, the arranging method goes on with the step of threading the revealed portion 22 of the conductive sheath 16 into the cylindrical ferrule 26 such that one 28 of the rings 28, 30, called the blocking ring 28, covers the end 24 of the revealed portion 22 of the conductive sheath 16, while the other ring 30, called the holding ring 30, is placed around the revealed portion 22 of the conductive sheath 16, next to the outer isolating sheath 18.

During a following step, the holding ring 30 is crimped around the revealed portion 22 of the conductive sheath 16, so as to hold the ferrule 26.

Turning to FIG. 5, the arranging method goes on with the step of pushing up the end 24 of the revealed portion 22 of the conductive sheath 16 along with the blocking ring 28 along the cable 10 toward the holding ring 30, i.e towards the outer insulating sheath 18, so as to reveal a portion 36 of the inner insulating sheath 14. During the pushing up, the blocking ring 28 maintains the end 24 of the revealed portion 22 of the conductive sheath 16 against, i.e. in contact with the inner insulating sheath 14. The pushing up causes the portion 22 of the conductive sheath 16 to crumple, forming an annular ripple 38. The pushing up also causes the stripes 32 to bend outwardly at the notches 34 in a V shape, so as to guide the forming of the ripple 38 and form a protecting cage 39 surrounding the ripple 38.

The ripple 38 is located along the cable 10 between the end 24 of the conductive sheath and the outer insulating sheath, and it rises up above the outer insulating sheath 18.

The blocking ring 28 is then crimped around the end 24 of the conductive sheath 16, next to the ripple 38, so as to block the revealed portion 22 of the inductive sheath 16 in the pushed up position, preventing it to move toward the end 20 of the cable 16.

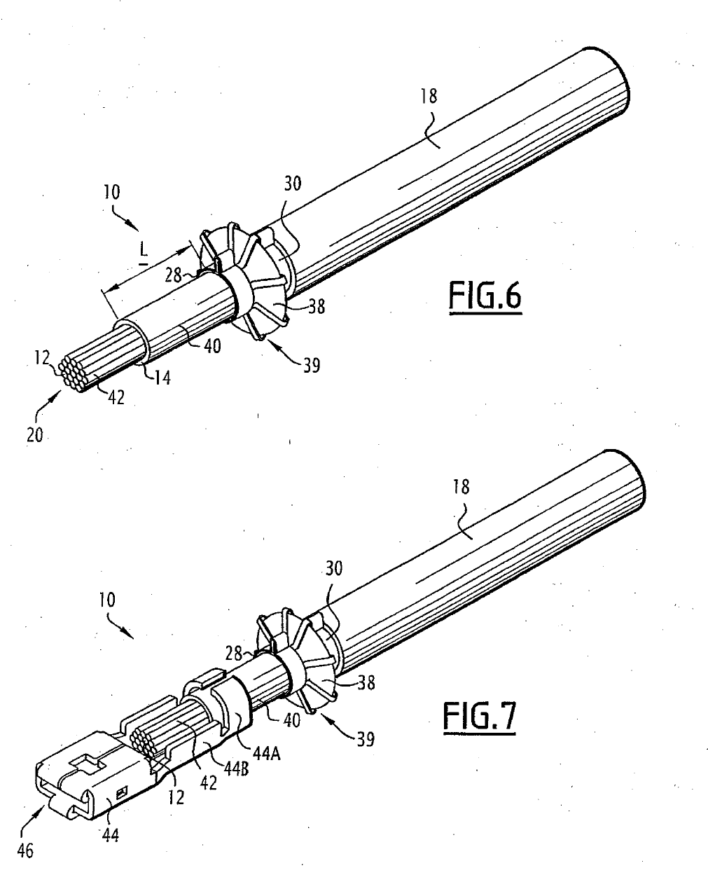

Turning to FIG. 6, the method then goes on with the step of stripping the inner insulating sheath 14 from the end 20 of the cable 10 on a part of the revealed portion 36 of the inner insulating sheath 14 so as to keep a remaining revealed portion 40 of the inner insulating sheath 14, and reveal a portion 42 of the cable core 12. The length L of the remaining portion 40 of the inner insulating sheath 14 along the cable 10 corresponds to the creepage distance which is chosen so as to prevent the formation of an electric arc between the cable core 12 and the conductive sheath 16 in operation, depending on the electrical tension and working conditions at which the cable 10 is intended to withstand.

Turning to FIG. 7, a contact 44 is connected to the arranged cable 10. The contact 44 comprises a part 44A crimped on the remaining revealed portion 40 of the inner insulating sheath 14, while having a part 44B in contact with the revealed portion 42 of the cable core 12.

The contact 44 defines a front face 46, opposite to the cable 10, for being connected with a counterpart contact (not shown).

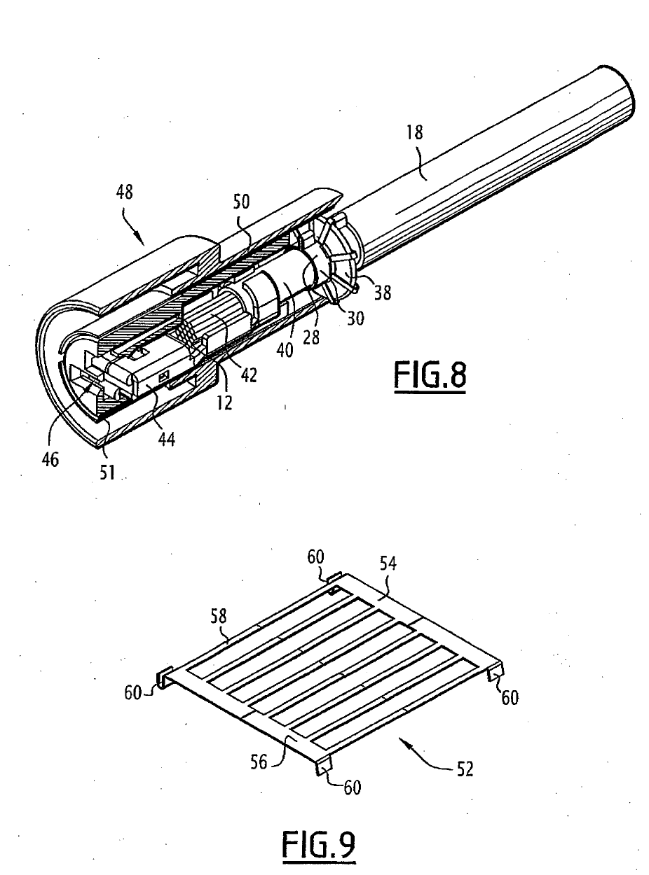

Turning to FIG. 8, a housing 48 is set around the contact 44 so as to form a complete connector. The housing 48 comprises a conductive sleeve 50, or shield, having a cylindrical shape surrounding the cable 10, and being in inner contact with the cage formed by the bent stripes 32. Preferably, the conductive sleeve 50 is in contact with all the stripes, so that a symmetric connection around the cable 10 is established, which ensures a good electrical connection. The housing 48 further comprises an insulating cylinder 51 interleaved between the contact 44 and the sleeve or shield 50. Preferentially this shield 50 spread over the length of housing 48 and can be connected to a corresponding shielding device on a counter part connector (not represented). This way an uninterrupted shielding can be ensured from the cable 18 until the electrical device to be connected with.

Turning to FIG. 9, a raw structure 52 from which the ferrule 26 is manufactured is illustrated.

The raw structure 52 is formed by a plane sheet of metal 54, stamped as a ladder having two uprights 56, intended to form the final rings 28, 30, and a plurality of equally spaced rungs 58, intended to form the final stripes 32.

The ends of the uprights 56 extend so as to form strips 60.

The rungs 58 are provided with the notches 34, located halfway between the two uprights 56.

In order to form the ferrule 26, the raw structure 52 is folded around a direction parallel to the rungs 58, so that the two ends of a same upright 56 are joined together.

For each upright 56, one of its strips 60 is crimped around the other of its strips 60, so as to fix the shape of the ferrule 26. The crimped strips 60 are illustrated on FIG. 3.

The resulting ferrule 26 is integral, obtained from one single piece, which is the raw structure 52.

1. A method for arranging a cable for the purpose of connecting the cable to a device, the cable comprising:
a conductive cable core,
an inner insulating sheath covering the cable core,
a conductive sheath covering the inner insulating sheath, and
an outer insulating sheath covering the conductive sheath, except for a revealed portion of the inductive sheath extending from an end of the cable, wherein the revealed portion has an end opposite the outer insulating sheath, the method being characterized in that it comprises the steps of:
while maintaining the end of the revealed portion of the conductive sheath in contact with the inner insulating sheath, pushing up the end of the revealed portion of the conductive sheath along the cable towards the outer insulating sheath for revealing a portion of the inner insulating sheath, and causing the revealed portion of the conductive sheath to crumple, forming an annular ripple, and
blocking the pushed up revealed portion of the conductive sheath.

2. The method according to claim 1, characterized in that it comprises the step of stripping the inner insulating sheath from the end of the cable on a part of the revealed portion of the inner insulating sheath so as to keep a remaining revealed portion of the inner insulating sheath.

3. The method according to claim 1, characterized in that the blocking step comprises crimping a blocking ring around the end of the pushed up revealed portion of the conductive sheath.

4. The method according to claim 3, characterized in that the blocking ring is fixed to a holding ring by a plurality of parallel stripes, the rings and the stripes as a whole forming a cylindrical ferrule in which each ring forms an end, and characterized in that the method further comprises the steps of:
threading the revealed portion of the conductive sheath into the cylindrical ferrule such that the blocking ring covers the free end of the revealed portion of the conductive sheath,
crimping the holding ring,
pushing up the revealed portion of the conductive sheath along with the blocking ring along the cable toward the holding ring, the blocking ring maintaining the end of the revealed portion of the conductive sheath against the inner insulating sheath, the pushing up causing the stripes to form a cage surrounding the ripple.

5. A cable comprising:
a conductive cable core,
an inner insulating sheath covering the cable core,
a conductive sheath covering the inner insulating sheath, and
an outer insulating sheath covering the conducting sheath, except for a revealed portion of the inductive sheath extending from an end of the cable, characterized in that the conductive sheath has an end against the inner insulating sheath, the end of the conductive sheath being located along the cable at a distance from the end of the cable, and defines an annular ripple located along the cable between the end of the conductive sheath and the outer insulating sheath.

6. A cable arrangement characterized in that it comprises:
a cable according to claim 5,
a first ring disposed around the end of the conductive sheath,
a second ring disposed around the conductive sheath, between the ripple and the outer insulating sheath,
a plurality of stripes extending from one ring to the other by forming a cage surrounding the ripple.

7. The cable arrangement of claim 6, characterized in that the stripes are equally disposed around the cable.

8. A ferrule for being used in the method of claim 4, characterized in that it comprises two coaxial rings axially spaced and fixed to each other
by a plurality of parallel stripes so as to substantially define a generally cylindrical shape.

9. The ferrule of claim 8, characterized in that the stripes are equally spaced around each ring.

10. The ferrule of claim 8, characterized in that each stripe is provided with a notch perpendicular to the direction of the stripe, the notch being located halfway between the two rings.

11. The ferrule of claim 8, characterized in that the ferrule is integral.

12. The ferrule of claim 11, characterized in that the ferrule is obtained by stamping and folding a plane sheet of metal.
